(19) United States
(12) Patent Application Publication
(10) Pub. No.: US 2011/0081625 A1
(43) Pub. Date: Apr. 7, 2011

(54) Denture

(75) Inventor: Lih-Jyh Fuh, Taichung City (TW)

(73) Assignee: China Medical University, Taichung City (TW)

(21) Appl. No.: 12/574,594

(22) Filed: Oct. 6, 2009

(51) Int. Cl. A61C 13/08

(52) U.S. Cl. 433/167; 340/10.1

(57) ABSTRACT

A denture is adapted to communicate with a radio frequency identification (RFID) reader. The denture includes a denture main body and at least one RFID tag embedded in the denture main body for storage of identification information of a user of the denture. The RFID tag transmits the information to the RFID reader by radio frequency wave.

### BACKGROUND OF THE INVENTION

1. Field of the Invention

The invention relates to a denture, more particularly to a denture adapted to communicate with a radio frequency identification (RFID) reader.

2. Description of the Related Art

Patients suffering from tooth decay, periodontal disease, and elders need to wear a partial denture or a complete denture. The partial denture and complete denture must be removed and cleaned after meals and at sleep time to ensure healthy oral cavity and gum.

However, the removable denture is apt to be misplaced and lost, especially in hospitals and nursing homes. Additionally, dentists have no explicit information to realize the conditions of use of the denture to facilitate further correction of the patients' habit of using the denture, and early treatment of the patients.

### SUMMARY OF THE INVENTION

Therefore, the object of the present invention is to provide a denture capable of alleviating the above drawbacks of the prior art.

Accordingly, a denture of the present invention is adapted to communicate with a radio frequency identification (RFID) reader, and includes adenture main body and at least one RFID tag embedded in the denture main body for storage of identification information of a user of the denture. The RFID tag transmits the information to the RFID reader by radio frequency wave.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a preferred embodiment of a denture according to the present invention; and

FIG. 2 is a block diagram of the preferred embodiment.

### DETAILED DESCRIPTION OF THE PREFERRED EMBODIMENT

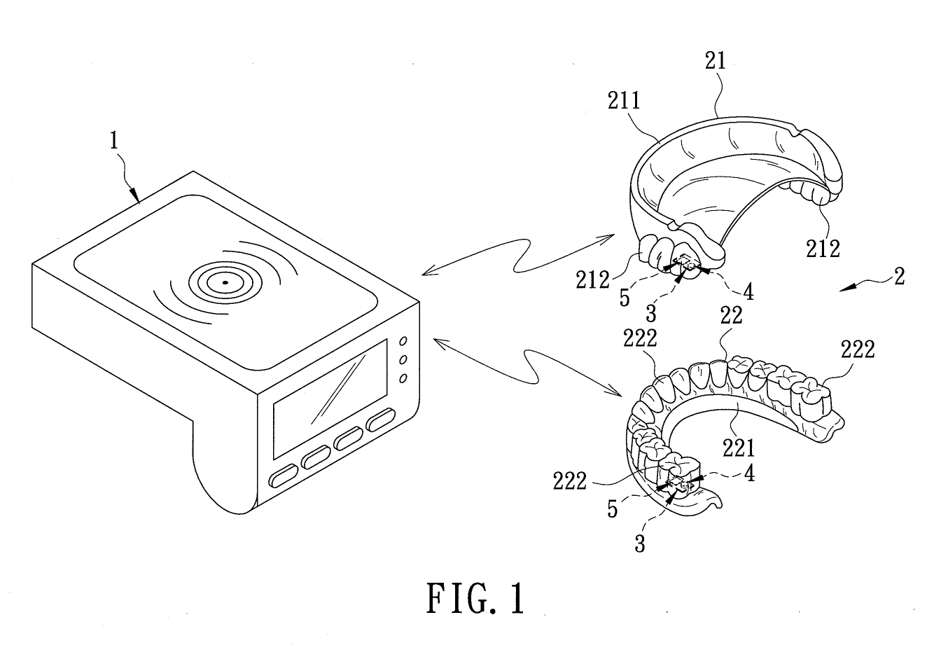

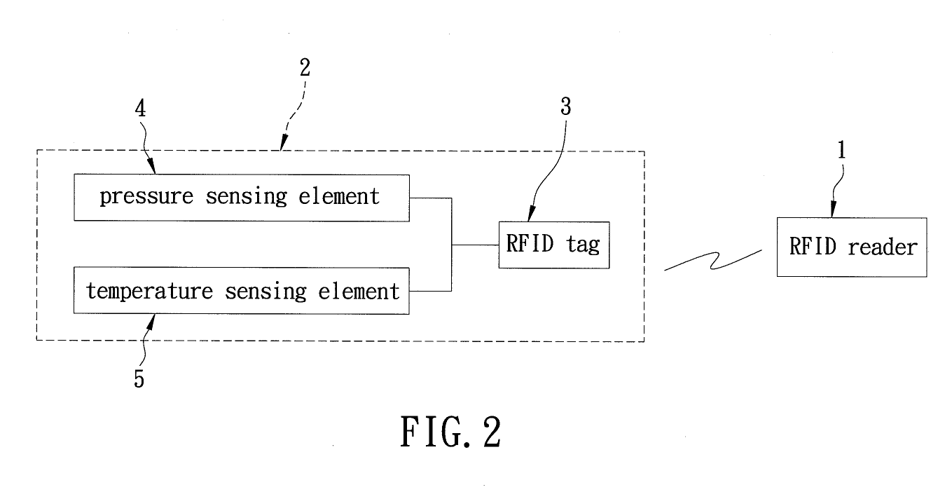

As shown in FIGS. 1 and 2, a preferred embodiment of a denture according to the present invention is adapted to communicate with a radio frequency identification (RFID) reader 1. The denture comprises a denture main body 2, two RFID tags 3, two pressure sensing elements 4, and two temperature sensing elements 5.

The denture main body 2 has an upper tooth portion 21 and a lower tooth portion 22. Each of the upper and lower tooth portions 21, 22 has a gum 211, 221, and a plurality of teeth 212, 222 implanted on the gum 211, 221.

The RFID tags 3 are embedded respectively in the upper tooth portion 21 and the lower tooth portion 22 of the denture main body 2 for storage of identification information of a user of the denture.

Each of the pressure sensing elements 4 is embedded in one of the teeth 212, 222 of a respective one of the upper tooth portion 21 and the lower tooth portion 22 of the denture main body 2. The pressure sensing elements 4 are electrically connected to and communicate with the RFID tags 3 by one of wireless and wired communication techniques for detecting a pressure variation of the denture main body 2 when subjected to an external force.

Each of the temperature sensing elements 5 is embedded in one of the teeth 212, 222 of a respective one of the upper tooth portion 21 and the lower tooth portion 22 of the denture main body 2. The temperature sensing elements 5 are electrically connected to and communicate with the RFID tags 3 by one of wireless and wired communication techniques for detecting a temperature variation of the denture main body 2.

It should be noted that the memory capacity of the RFID tags 3 can be up to several Megabytes. RFID tags can be active RFID tags (with battery) or passive RFID tags (without battery). In this embodiment, the RFID tags 3 are active RFID tags including batteries (not shown) for providing electricity required for emission of electromagnetic waves to the RFID reader 1. The RFID reader 1 charges the RFID tags 3 when the RFID tags 3 are disposed in an area of responsibility of the RFID reader 1.

The RFID tags 3 transmit the information to the RFID reader 1 by radio frequency wave. Alternatively, the RFID reader 1 emits radio waves to the RFID tags 3 to thereby enable the RFID tags 3 to respond to the RFID reader 1 by emitting radio frequency waves. An input device (not shown) of the RFID reader 1 is for inputting the user information, such as name, blood type, age, ID number, medical treatment records, etc.

The pressure sensing elements 4 detect the pressure variation of the denture main body 2 when the upper and lower tooth portions 21, 22 are moved into contact with each other. Hence, a corresponding pressure variation value is stored in the RFID tags 3 in response to detection by the pressure sensing elements 4. The temperature sensing elements 5 detect the temperature variation of the denture main body 2. Hence, a corresponding temperature variation value is stored in the RFID tags 3 in response to detection by the temperature sensing elements 5.

Accordingly, the RFID reader 1 reads out the information stored in the RFID tags 3 directly when the user undergoes dental treatment. Therefore, dentists can be aware of the conditions of use of the denture main body 2 (e.g., the removal frequency and hours of the denture main body) so as to increase treatment accuracy and so as to comply with timing of treatment.

To sum up, the advantages of the denture according to the present invention are as follows. In the present invention, since the user information is stored in the RFID tags 3, the RFID reader 1 can read out the information to thereby avoid misplacing of the denture main body 2, especially in hospitals and nursing homes. The dentists can be aware of the conditions of use of the denture main body 2, and variation of gums of the user to further facilitate correction of the patient's habit of using the denture, and early treatment of the patients.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A denture adapted to communicate with a radio frequency identification (RFID) reader, said denture comprising:
a denture main body; and
at least one RFID tag embedded in said denture main body for storage of identification information of a user of said denture, said RFID tag transmitting the information to said RFID reader by radio frequency wave.

2. The denture as claimed in claim 1, further comprising at least one sensing element embedded in said denture main body for detecting variation of said denture main body to thereby emit a corresponding signal to said RFID tag, and storing a corresponding variation value in said RFID tag.

3. The denture as claimed in claim 2, wherein said sensing element is electrically connected to said RFID tag.

4. The denture as claimed in claim 2, wherein said sensing element is for detecting a pressure variation of said denture main body when subjected to an external force, a corresponding pressure variation value being stored in said RFID tag in response to detection by said sensing element.

5. The denture as claimed in claim 2, wherein said sensing element is for detecting a temperature variation of said denture main body, a corresponding temperature variation value being stored in said RFID tag in response to detection by said sensing element.

6. The denture as claimed in claim 2, comprising two of said sensing elements, wherein one of said sensing elements is a pressure sensing element for detecting a pressure variation of said denture main body when subjected to an external force, and the other one of said sensing elements is a temperature sensing element for detecting a temperature variation of said denture main body.
